(19) United States
(12) Patent Application Publication
(10) Pub. No.: US 2007/0300183 A1
(43) Pub. Date: Dec. 27, 2007

(54) Pop-up notification for an incoming message

(75) Inventors: Akseli Anttila, Helsinki (FI); Harri Wikberg, Helsinki (FI); Kirsi Karimaki, Tampere (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/472,836

(22) Filed: Jun. 21, 2006

(51) Int. Cl. G06F 3/048

(52) U.S. Cl. 715/808

(57) ABSTRACT

A method including: receiving an incoming message; parsing the content of the incoming message to identify content of the incoming message; and creating a pop-up notification that depends upon identified content.

### FIELD OF THE INVENTION

Embodiments of the present invention relate to pop-up notification for an incoming message. In particular, they relate to a method, computer program product and a device for providing a pop-up notification for an incoming message.

### BACKGROUND TO THE INVENTION

In current mobile messaging systems a user of a recipient device is presented with minimal information when an incoming message is received. For example, the user may only be informed that a message has been received, the type of message e.g. email, short messaging service (SMS) message or Multimedia Messaging Service (MMS) message. It is therefore difficult for the user to judge whether or not the she should open the message now, later or not at all.

### BRIEF DESCRIPTION OF THE INVENTION

According to one embodiment of the invention there is provided a method comprising: receiving an incoming message; parsing the content of the incoming message to identify content of the incoming message; and creating a pop-up notification that depends upon identified content.

According to another embodiment of the invention there is provided a computer program product comprising computer program instructions for: parsing the content of an incoming message to identify content of the incoming message; and creating a pop-up notification that depends upon identified content.

According to another embodiment of the invention there is provided a device comprising: a receiver for receiving an incoming message; a parser for parsing the content of the incoming message to identify content of the incoming message; and a display for displaying a pop-up notification that depends upon identified content.

### BRIEF DESCRIPTION OF THE DRAWINGS

For a better understanding of the present invention reference will now be made by way of example only to the accompanying drawings in which:

FIG. 1 schematically illustrates an electronic communications device;

FIG. 2 schematically illustrates an example of an incoming message;

FIG. 3 illustrates a method of automatically creating a pop-up notification for an incoming message; and

FIG. 4 schematically illustrates a pop-up notification for an incoming message.

### DETAILED DESCRIPTION OF EMBODIMENTS OF THE INVENTION

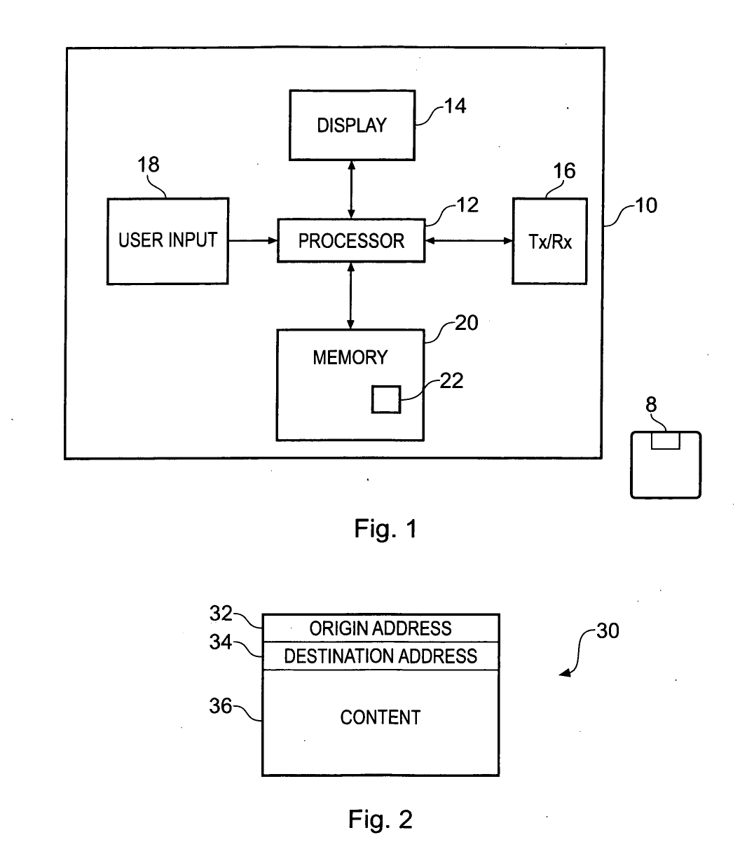

FIG. 1 schematically illustrates an electronic communications device 10 comprising: a processor 12, a memory 20, a user input device 18, a display 14 and a communications interface 16. In this example, the communications interface 8 is a cellular radio transceiver that enables the electronic communications device 10 to operate in a mobile cellular telecommunications network. The memory 20 stores computer program instructions 22.

In this example, the electronic communications device 10 is a mobile cellular telephone and the communications interface 16 is a cellular radio transceiver. However, the invention has application to any electronic communications device that it capable of receiving an incoming message and has a display for displaying a pop-up notification of the incoming message.

Only as many components are illustrated in the figure as are referred to in the following description. It should be appreciated that additional different components may be used in other embodiments of the invention. For example, although a program processor 12 is illustrated in FIG. 1 any appropriate controller may be used such as a dedicated processor e.g. an application specific integrated circuit or similar.

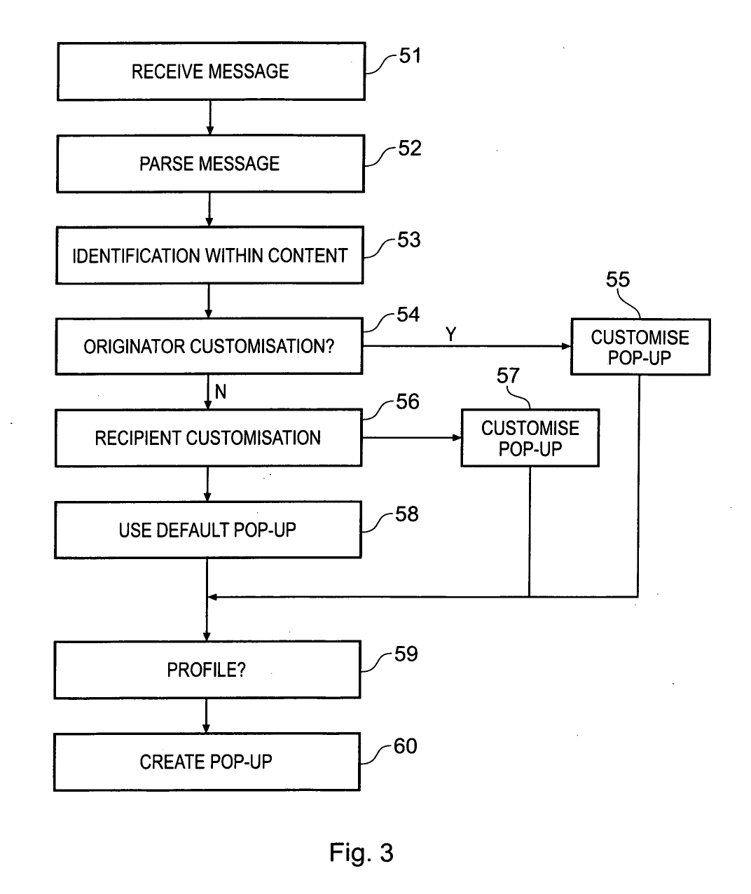

The processor 12 is connected to read from and write to the memory 20, to provide control signals to the display 14, to receive control signals from the user input 16 and to provide data to the communications interface 16 for transmission and to receive from the communications interface 16 data that has been received at the device 10 such as an incoming message. Computer program instructions 22 stored in the memory 20 control the operation of the electronic communications device 10 when loaded into the processor 12. The computer program instructions 22 provide the logic and routines that enable the electronic communications device 10 to perform the method illustrated in FIG. 3.

The computer program instructions may arrive at the electronic communications 10 via an electro-magnetic carrier signal or may be copied from a physical entity 8 such as a computer program product, memory device or a record medium such as a CD-ROM or DVD.

FIG. 2 schematically illustrates an example of an incoming message 30. The incoming message 30 comprises a portion 32 that identifies the origin of the message 30, a portion 34 that identifies the destination of the message 30 and a portion 36 that comprises the message content. The message content may be any suitable content. For example, it may comprise text, audio files, video etc.

Although the incoming message 30 is illustrated as a single entity, it may be provided as multiple separate sub-messages. For example, a first sub-message may include the portion 32 and portion 34 and a part of the content 36. The part of the content 36 included in the first sub-message may include a link that enables a user to access a server and download a second sub-message that contains the remainder of the content 36.

The first sub-message may be, for example, an M-notification.ind pdu of an Multimedia Messaging Service (MMS) message. Such a message has a “subject” field which is a free formed text field that allows a user to identify the subject of a message and also has a “priority-value” field that allows an originator of the message to indicate a priority of the MMS.

The originator of the message 30 may be able to use the subject field to include as a text string data that controls the creation of a pop-up notification 40 when the message 30 is received at the electronic communications device 10.

For example, the originator of the message may be able to indicate the urgency of the message using the priority field and the subject field may be used to include a code that indicates that the message content 36 includes audio such that when the second sub-message is downloaded an audio output will be produced. The subject field may also be used by the originator of the message 30 to include a free formed text summary of the content 36 of the message 30.

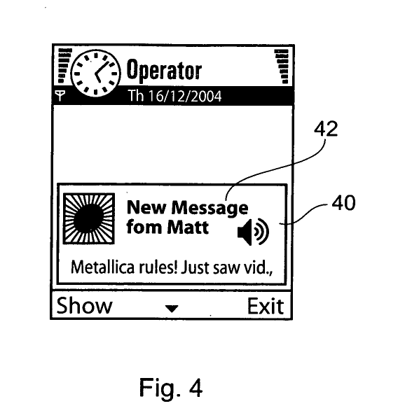

FIG. 4 schematically illustrates a pop-up notification 40 for an incoming message 30. The pop-up notification 40 has a text portion 42 which indicates who sent the message i.e. who the originator of the message 30 is. In the example illustrated, this portion reads “New Message from Matt”. The message may be generated automatically using the portion 32 of the message 30 that identifies the origin of the message 30. A portion 44 of the pop-up notification 40 provides an icon that indicates the content of the incoming message 30. In this example, the icon indicates that the content 36 of the incoming message 30 comprises audio and is therefore likely to make a noise when the message is opened. It should be appreciated that other types of icons may be used for other types of content, for example a camera icon may be used to indicate video and a page icon may be used to indicate text. A portion 46 of the pop-up notification 40 gives an indication of what the message 30 relates to. In the example illustrated, the portion 46 includes the first few words of the text within the message content 36. In other examples, the originator of the message may be able to define a text string that is specifically for presentation in the portion 46, for example, using the subject field of an MMS message.

A portion 48 of the pop-up notification 40 is an image thumbnail. This thumbnail may be a representation of an image comprised in the message content 36, or may be an image that relates to the originator of the message 30 stored at the recipient device 10.

FIG. 3 illustrates a method 50 of automatically, without user intervention, creating a pop-up notification 40 at a device 10 in response to receipt of an incoming message 30 at the device 10.

At step 51, an incoming message 30 is received. Next at step 52 the incoming message 30 is parsed by the processor 12 (the parser) and at step 53 content within the message 30 is identified. Such content may, for example, be control attributes introduced by the originator of the message to customize a pop-up notification 40. Alternatively, the content may relate to different media types, and the media type of the content is identified so that the appropriate icon 44 may be displayed in a pop-up notification 40.

Next at step 54 the process decides whether or not originator customization is appropriate. If originator customization is enabled at the communications device 10 and originator defined attributes are defined within the content 36 of the incoming message 30 then the process moves from step 53 to step 55 where the pop-up notification 40 is customized in accordance with the originator specified attributes. The originator may, for example, have specified the urgency of the message, specified what icon 44 should be displayed in the pop-up notification 40, specified what text string should be displayed in the portion 46, specified what image should be displayed in the thumbnail 48, specified whether an animation should be included within the pop-up notification 40 and/or specified what form the alert should take when the incoming message 30 is received at the communications device 10.

The extent to which the originator may customize the pop-up notification 40 may be dependent upon the level of trust the originator of the message 38 has. The communications device 10 may maintain a database that records against message originator identities a level of trust. When an incoming message is received, it includes an originator identity which is then used to query the database. The database returns a level of trust. If the level of trust is very high then the originator may have full rights to customize the pop-up notification 40. If, however, the level of trust is lower certain aspects of customization may be inhibited. The user of the communications device 10 may program what customization rights, which levels of trust have. The user of the device may also be able to program the database to record specific trust levels against specific persons.

If the level of trust is low or unknown, then the pop-up notification may indicate that the received message includes sender defined behavior and give the user of the communications device 10 the option of enabling the sender defined behavior or disabling the sender defined behavior. If the sender defined behavior is disabled, the process then moves to step 56. Otherwise at step 55 customization of the pop-up continues as described above. After step 55 the process moves to step 59.

Next at step 56, the process decides whether or not recipient customization is enabled. If it is, the process moves to step 57. If it is not, the process moves to step 58. At step 57, the pop-up notification 40 is customized according to customization settings created by the user of the communications device 10. These settings may, for example, control the content of the icon 44, the thumbnail 48, the alert used when an incoming message is received, the message background, the color used, the font used etc. The user of the communications device 10 may be able to program via a contacts database (phonebook) of the communications device the customization settings for a pop-up notification 40 for each of several different users. It would therefore be possible to have pop-up notifications 40 that are different for identical messages received from different parties. After step 57, the process moves to step 59.

At step 58, if originator or recipient customization is not enabled, then a default pop-up notification format is used. The process then moves to step 59.

At step 59, the operational profile of the communications device 10 is determined. For example, the communications device 10 may have any one of a number of different profiles such as silent operation, discrete operation, normal operation, loud operation. These profiles typically control the extent to which the communications device disturbs its environment when it produces an alert such as, for example, when there is an incoming telephone call or an incoming message 30.

The nature of the pop-up notification may be modified at step 59 so that it corresponds to the current profile of the communications device 10. Thus for example if the profile is set to silent, the pop-up notification will be amended to prevent audio output.

The process then moves to step 60 where the pop-up notification is created by presentation on the display 14.

Although embodiments of the present invention have been described in the preceding paragraphs with reference to various examples, it should be appreciated that modifications to the examples given can be made without departing from the scope of the invention as claimed.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A method comprising:
receiving an incoming message;
parsing the content of the incoming message to identify content of the incoming message; and
creating a pop-up notification that depends upon identified content.

2. A method as claimed in claim 1, wherein the pop-up notification includes multiple information items including an item that identifies from whom the message was sent and an item that identifies what the message contains.

3. A method as claimed in claim 1, wherein the pop-up notification includes an icon indicating that the incoming message contains audio content.

4. A method as claimed in claim 1, wherein the pop-up notification includes an icon indicating that the incoming message contains video content.

5. A method as claimed in claim 1, wherein the pop-up notification includes a thumbnail picture displaying at least a portion of image content.

6. A method as claimed in claim 1, wherein the pop-up notification includes a string defined by an originator of the message.

7. A method as claimed in claim 1, wherein the incoming message comprises an originator defined attribute that controls the pop-up notification.

8. A method as claimed in claim 7, wherein the originator defined attribute defines one or more of: an urgency; an icon displayed in the pop-up notification; an
animation provided in the pop-up notification; an alert associated with pop-up notification, and a summary for display in pop-up notification.

9. A method as claimed in claim 1, wherein the pop-up notification depends upon a trust level associated with the originator of the message.

10. A method as claimed in claim 1, wherein the pop-up notification has a form that is customisable by predetermined pop-up settings of the receiving device.

11. A method as claimed in claim 1, wherein the pop-up notification has a customisable form that is dependent upon the originator of the message.

12. A method as claimed in claim 1, wherein the pop-up notification is dependent upon which one of several user-selectable profiles the receiving device is in when the incoming message is received.

13. A method as claimed in claim 1, wherein the pop-up notification is dependent upon, in order of priority, specifications made by the sender of the message, specifications made by the recipient of the message, and default specifications.

14. A computer program product comprising computer program instructions for:
parsing the content of an incoming message to identify content of the incoming message; and
creating a pop-up notification that depends upon identified content.

15. A device comprising:
a receiver for receiving an incoming message;
a parser for parsing the content of the incoming message to identify content of the incoming message; and
a display for displaying a pop-up notification that depends upon identified content.

16. A method as claimed in claim 15, wherein the device is operable to identify from whom the message was sent and what the message contains and wherein the pop-up notification includes multiple information items including an item that identifies from whom the message was sent and an item that identifies what the message contains.

17. A method as claimed in claim 15, wherein the device is operable to identify that the incoming message contains audio content and wherein the pop-up notification includes an icon indicating that the incoming message contains audio content.

18. A method as claimed in claim 15, wherein the device is operable to identify that the incoming message contains video content and wherein the pop-up notification includes an icon indicating that the incoming message contains video content.

19. A method as claimed in claim 15, wherein the device is operable to identify an image within the incoming message content and wherein the pop-up notification includes a thumbnail picture displaying at least a portion of the image.

20. A method as claimed in claim 15, wherein the device is operable to identify a string defined by an originator of the message and wherein the pop-up notification includes the identified string.

21. A method as claimed in claim 15, wherein the device is operable to identify a attribute defined by an originator of the message and to use the identified attribute to control the pop-up notification.

22. A method as claimed in claim 15, wherein the device is operable to stored trust indications and wherein the pop-up notification depends upon a trust level associated with the originator of the message.

23. A method as claimed in claim 15, wherein the device is operable to customise a pop-up notification according to predetermined user settings.
